(19) United States
(12) Patent Application Publication
(10) Pub. No.: US 2006/0150223 A1
(43) Pub. Date: Jul. 6, 2006

(54) Digital TV broadcast signal receiving system and outdoor appliance used therein

(75) Inventor: Masahiro Matsuo, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/292,100

(22) Filed: Dec. 2, 2005

(30) Foreign Application Priority Data
Dec. 2, 2004 (JP) 2004-349811

(51) Int. Cl. H04N 7/18

(52) U.S. Cl. 725/81; 725/74; 725/78

(57) ABSTRACT

In a digital TV broadcast signal receiving system using a multi-directional antenna, an outdoor appliance comprises an antenna controller for controlling an effective signal receiving direction of the multi-directional antenna, a tuner for receiving a TV broadcast signal, a signal demodulator for demodulating the TV broadcast signal, and a first wireless interface for transmitting data with a second wireless interface provided in an indoor appliance. The indoor appliance further has a signal decoder for separating an audio signal and a visual signal and outputs them to a monitor apparatus. An appliance such as a personal computer having no tuner circuit can receive the. TV broadcast signal if it has a wireless interface such as a wireless LAN. Furthermore, the data communication between the outdoor appliance and the indoor appliance is performed by wireless interfaces, so that a cable connecting between an outdoor appliance and an indoor appliance can be omitted.

### BACKGROUND OF THE INVENTION

1. Field of the Invention

The present invention relates to a digital TV (television) broadcast signal receiving system to which a multi-directional antenna having a plurality of signal receiving directions is connected and an outdoor appliance used therein.

2. Description of the Related Art

As shown in FIG. 4, a digital TV broadcast signal receiving system to which a multi-directional antenna such as a smart antenna is connected is conventionally constituted by an antenna control apparatus 105 for controlling an effective signal receiving direction of the multi-directional antenna, and a set top box 120 including a tuner 106, a signal demodulator 107, a signal decoder 112, a control unit 113 for controlling each department of the set top box 120, and so on. The antenna control apparatus 105 and the set top box 120 are placed in an indoor location such as user's house. Therefore, a modular cable 121 for inputting a control signal and a drive voltage to the multi-directional antenna 130 and a coaxial cable 122 for transmitting a broadcast signal (RF signal) received by the multi-directional antenna 130 to the tuner 106 are laid into the indoor from an outdoor of the house, and these cables are connected to the antenna control apparatus 105.

In such a conventional digital TV broadcast signal receiving system, wiring operation for laying and connecting the cables from the multi-directional antenna 130 placed in the outdoor location to the antenna control apparatus 105 placed in the indoor location is complex and troublesome, so that it causes the increase of the cost for working charge. Furthermore, when a plurality of the set top boxes 120 is installed in a plurality of rooms, it is necessary to arrange the modular cables 123 and the coaxial cables 124 for connecting between the antenna control apparatus 105 and each set top box 120, so that it causes the complication of the wiring operation. Still furthermore, when the layout of the antenna control apparatus 105 and/or the set top box 120 in each room is modified, lengths of the modular cables 121 and/or the coaxial cables 122 which are already wired may cause the restriction of layout of the antenna control apparatus 105 and/or the set top box 120. Still furthermore, since the modular cables 121 and the coaxial cables 122 are laid along indoor walls, it spoils the beauty in the room.

Therefore, Japanese Laid-Open Utility Model Publication No. 6-66150 shows a TV broadcast signal receiver in which signal transmission between a satellite broadcast signal receiving antenna placed in an outdoor location and a tuner placed in an indoor location is performed by a wireless transmission system. In such a conventional TV broadcast signal receiver, it, however, is necessary to provide a tuner and a demodulator in each receiver. Thus, for example, in a personal computer into which no tuner and no demodulator are installed cannot receive the TV broadcast signal. In addition, the TV broadcast signal receiver cannot receive the digital TV broadcast signal.

On the other hand, Japanese Laid-Open Patent Publication No. 6-29735 shows a communication antenna system in which a solar cell and a secondary battery for accumulating charge of electricity generated by the solar cell are provided on an outdoor appliance, and a frequency converter is driven by charge of electricity generated by the solar cell, discharged electricity from the secondary battery or power supply from an indoor appliance. In such a communication antenna system, the outdoor appliance and the indoor appliance are connected with the coaxial cable similar to the conventional TV broadcast signal receiving system shown in FIG. 4, so that the above-mentioned problems of the conventional TV broadcast signal receiving system cannot be solved. In addition, International Publication WO 02/03092 A1 shows a multi-directional antenna in which a convergence parameter can be changed for improving performance of the multi-directional.

### SUMMARY OF THE INVENTION

The present invention is done to solve the above mentioned problem, and purposed to provide a digital TV broadcast signal receiving system by which no cable laid from an outdoor appliance to an indoor appliance is needed and digital TV broadcast signal can be received by an apparatus such as a personal computer having no tuner circuit, and to provide an outdoor appliance used therein.

A digital TV broadcast signal receiving system in accordance with an aspect of the present invention is comprised of an outdoor appliance placed in an outdoor location and an indoor appliance placed in an indoor location.

The outdoor appliance has an antenna controller to which a multi-directional antenna is connected and which controls an effective signal receiving direction of the multi-directional antenna, a tuner for receiving a TV broadcast signal through the multi-directional antenna and the antenna controller, a signal demodulator for demodulating the TV broadcast signal received by the tuner, a first main controller for controlling each department of the indoor appliance, and a first wireless interface for transmitting the demodulated signal by a format in compliance with a predetermined technical standard.

The indoor appliance has a second wireless interface for receiving the demodulated signal transmitted from the first wireless interface in compliance with the predetermined technical standard, a signal decoder for decoding the demodulated signal received by the second wireless interface, separating the demodulated signal into an audio signal and a visual signal and outputting them to a monitor apparatus, and a second main controller for controlling each department of the indoor appliance.

By such a configuration, the digital TV broadcast signal can be received by the indoor appliance with no cable connecting between the outdoor appliance and the indoor appliance laid into the indoor from the outdoor. Furthermore, since the tuner is provide on the outdoor appliance, the indoor appliance such as a personal computer having only a wireless interface and no tuner circuit can receive the TV broadcast signal.

In the above-mentioned digital TV broadcast signal receiving system, it is preferable to constitute that the second main controller outputs a control signal when reception channel is changed by a user; the second wireless interface transmits the control signal to the first wireless interface in compliance with the predetermined technical standard; the first wireless interface receives the control signal in compliance with the predetermined technical standard and outputs the received control signal to the first main controller; the first main controller changes reception frequency of the tuner corresponding to the control signal, judges whether a signal receiving direction of a changed reception channel is same as that of a previously set reception channel or not, and when the signal receiving direction of the changed reception channel is not the same as that of the previously set reception channel, the first main controller further outputs an antenna control signal to the antenna controller corresponding to the changed reception channel; and the antenna controller outputs the antenna control signal and supplies drive voltage to the multi-directional antenna for changing the effective signal receiving direction, thereby, the effective signal receiving direction of the multi-directional antenna can be optimized corresponding to the reception channel.

By such a configuration, the reception channel of the tuner can be changed from the indoor appliance, and the effective signal receiving direction of the multi-directional antenna is changed to maintain the signal receiving condition of the multi-directional antenna in optimum state.

On the other hand, an outdoor appliance used in a digital TV broadcast signal receiving system in accordance with another aspect of the present invention comprises an antenna controller to which a multi-directional antenna is connected and which controls an effective signal receiving direction of the multi-directional antenna, a tuner for receiving a TV broadcast signal through the multi-directional antenna and the antenna controller, a signal demodulator for demodulating the TV broadcast signal received by the tuner, a main controller for controlling each department of the indoor appliance, a wireless interface for transmitting the demodulated signal by a format in compliance with a predetermined technical standard with another wireless interface provided in an indoor apparatus placed in an indoor location, and a solar cell for supplying electric power to each department of the outdoor appliance and to the multi-directional antenna.

By such a configuration, the outdoor appliance can be used in the above-mentioned digital TV broadcast signal receiving system.

### BRIEF DESCRIPTION OF THE DRAWINGS

FIG. 1 is a conceptual view showing a user's house where a digital TV broadcast signal receiving system in accordance with an embodiment of the present invention is introduced into and a circumference thereof;

FIG. 2 is a block diagram showing an electric configuration of the above mentioned digital TV broadcast signal receiving system;

FIG. 3 is a block diagram showing a schematic arrangement of elements constituting an outdoor appliance in the above system; and

FIG. 4 is a block diagram showing an electric configuration of a conventional digital TV broadcast signal receiving system.

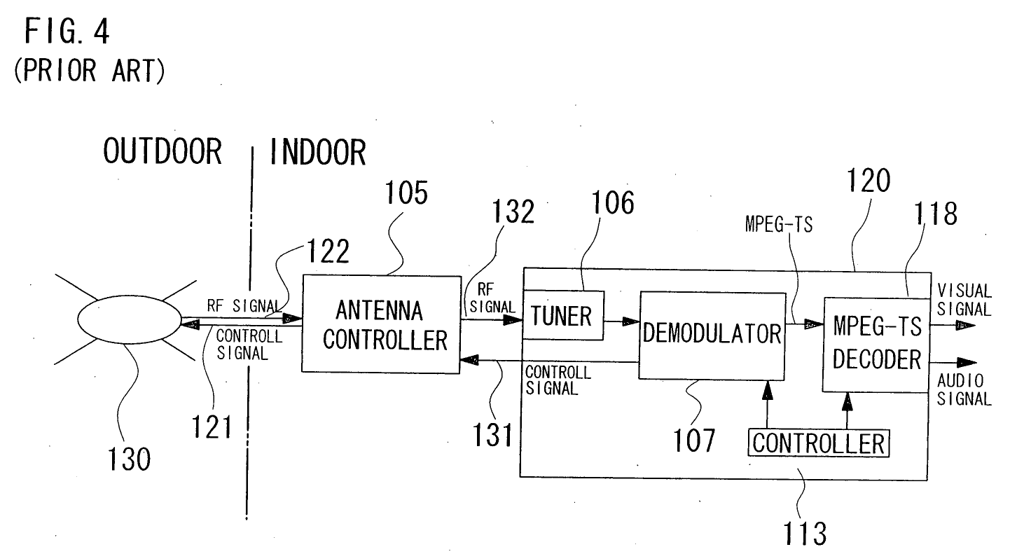

### DETAILED DESCRIPTION OF THE EMBODIMENT

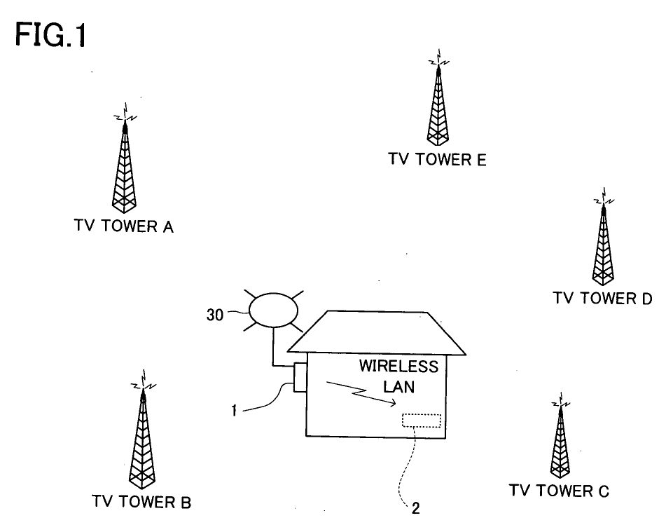

A digital TV broadcast signal receiving system in accordance with an embodiment of the present invention is described with reference to figures. FIG. 1 schematically shows a circumference of a user's house where this system is introduced into. TV towers A to E, each of which delivers at least one digital TV broadcast signal of a TV station, are deployed for surrounding urban distinct. In such an area, signal receiving directions of the digital TV broadcast signals of respective TV stations (TV reception channels) which are transmitted from the TV towers A to E are different, so that a multi-directional antenna which can change an effective signal receiving direction corresponding to the directions of the TV towers A to E is used. The digital TV broadcast signal receiving system in accordance with this embodiment uses a multi-directional antenna 30 called smart antenna and is comprised of an outdoor appliance 1 placed in an outdoor location, and an indoor appliance 2 placed in an indoor location. The digital TV broadcast signals (RF signals) transmitted from the TV towers A to E are compressed and encoded in compliance with the MPEG technical standard.

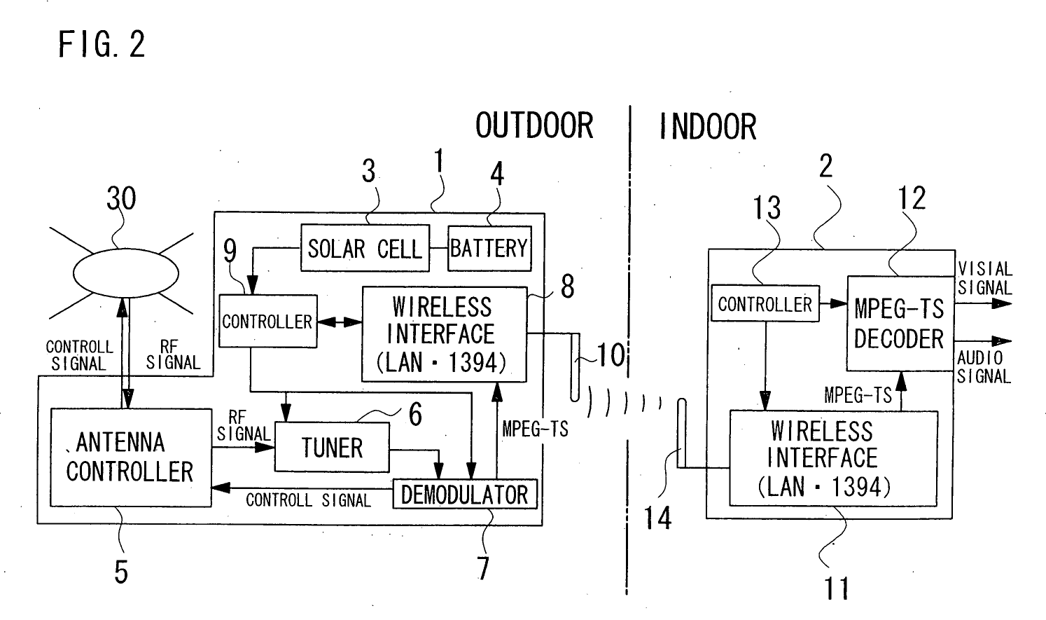

FIG. 2 shows a configuration of the digital TV broadcast signal receiving system. The multi-directional antenna 30 is controlled to change the effective signal receiving direction on the basis of a control signal outputted from an antenna control circuit (antenna control means) 5. The outdoor appliance 1 is located in the vicinity of the multi-directional antenna 30, for example, on an exterior wall of a user's house, and the indoor appliance 2 is placed in the vicinity of, for example, a monitor apparatus such as an LCD display (not illustrated).

The outdoor appliance 1 is comprised of a solar cell (photovoltaic means) 3 which generates electric power by reception of solar light, an accumulator battery 4 which accumulates electric power generated by the solar cell 3 and supplies the electric power to each department of the outdoor 1 and the multi-directional antenna 30, an antenna controller 5 for controlling changing or switching of the effective signal receiving direction of the multi-directional antenna 30, a tuner 6 for receiving a TV broadcast signal through the multi-directional antenna 30 and the antenna controller 5, a signal demodulator (signal demodulation means) 7 for demodulating the TV broadcast signal received by the tuner 6, a first wireless interface 8 for communicating with the indoor appliance 2 by wireless data communication, and a first main controller (first control means) 9 constituted by a CPU and so on for controlling each department of the outdoor appliance 1.

The indoor appliance 2 is comprised of a second wireless interface 11 for communicating with the outdoor appliance 1 by wireless data communication, a signal decoder (signal decoding means) 12 which decodes a signal received by the second wireless interface 11, separates into audio signal and visual signal, and outputs the audio signal and the visual signal, and a second main controller (second control means) 13. The data communication between the outdoor appliance 1 and the indoor appliance 2 is performed by wireless communication, so that there is no cable commented between them.

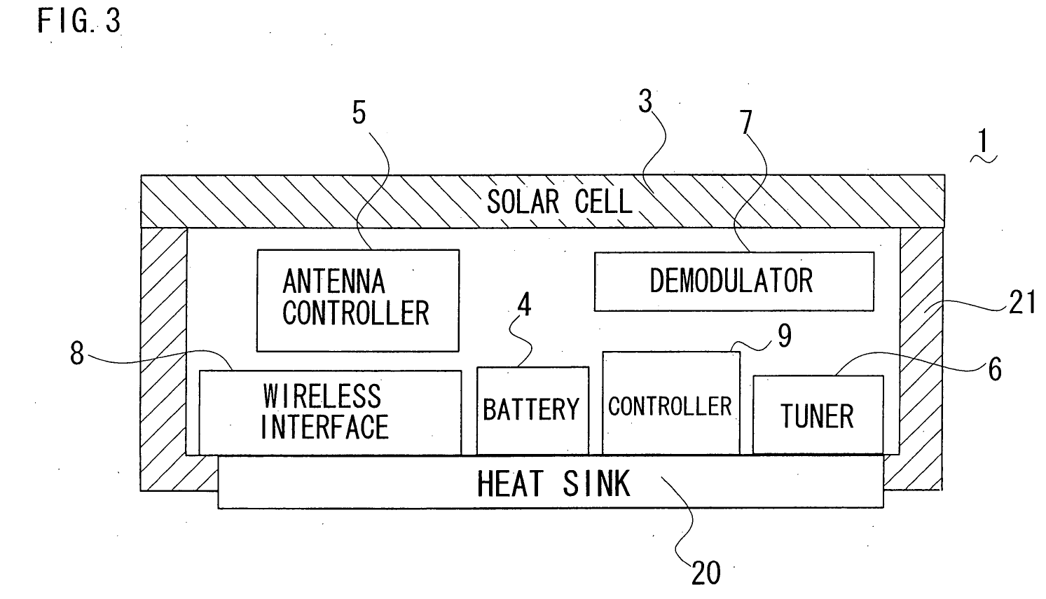

FIG. 3 shows an example of arrangement of each block in an inside of the outdoor appliance 1. The solar cell 3 is provided on a top face or a front face of a housing 21 of the outdoor appliance 1 in consideration of light receiving efficiency. A heat sink 20 is provided on an opposite face, that is, a bottom face or a rear face of the housing 21 of the outdoor appliance 1 for radiating heat generated by electronic elements mounted in an inside of the outdoor appliance 1. Specifically, the accumulator battery 4, the tuner 6, the first wireless interface 8 and the first main controller 9 which generate relatively large quantity of heat are mounted on the heat sink 20. On the other hand, the signal demodulator 7 and the antenna controller 5 which generate relatively small quantity of heat are provided between the solar cell 3 and the accumulator battery 4 and so on mounted on the heat sink 20. The housing 21 has properties of adiathermanous and waterproof, so that each element in the inside of housing 21 of the outdoor appliance 1 is protected from heat and water by the heat sink 20 and the housing 21.

The outdoor appliance 1 is generally in sunny place such as the external walls of the user's house so that a front face of the solar cell 3 is illuminated by sunlight. For example, in daylight of the summertime, the temperature of the outdoor appliance 1 rises due to heat generated by direct sunlight and the electronic elements of the outdoor appliance 1, so that S/N of the RF signal received by the tuner 6 may become worse. Therefore, the solar cell 3 is provided on the top face or the front face of the outdoor appliance 1 in this embodiment, so that the optical or thermal energy of sunlight is effectively converted to electric energy and the temperature rise of the outdoor appliance 1 is restrained. In addition, heat by sunlight irradiated on the side faces of the outdoor appliance 1 on which no solar cell is provided can be insulated by the housing 21, so that the temperature rise of in the inside of the outdoor appliance 1 can be restrained to a minimum.

The first wireless interface 8 and the second wireless interface 11 are in compliance with a predetermined wireless LAN technical standard (for example, IEEE802.11x) or IEEE 1394 technical standards, and can perform bidirectional communication each other through antennas 10 and 14. Specifically, an MPEG-TS signal which is demodulated by the signal demodulator 7 is transmitted to the second wireless interface 11 from the first wireless interface 8, and a control signal such as channel alternation is transmitted to the first wireless interface 8 from the second wireless interface 11. By the way, while the data communication can be performed with a bit rate of 50 Mbps in recent wireless LAN technical standard, the bit rate of the MPEG-TS signal is about 20 Mbps in the best picture quality mode. Thus, it is possible to perform data transmission of RF signals of different channels between a single outdoor appliance 1 including a plurality of lineages of the tuners 6 and the signal demodulators 7 and a plurality of indoor appliances 2.

Signal decoder 12 decodes the MPEG-TS signal, separates into the audio signal and visual signal and outputs the separated audio signal and visual signal to the monitor apparatus. Such a decoding function can be realized by a personal computer into which software of MPEG decoding is installed. Furthermore, the above mentioned second wireless interface 11 can be built-in the personal computer or externally connected to the personal computer. Therefore, in this embodiment, a general-purposed personal computer, which comprises the second wireless interface 11, can be applied for the indoor arrangement 2 other than the set top box.

In the digital TV broadcast, digital signal coded in compliance with the MPEG-2 technical standard is delivered at the present time, so that the signal decoder 12 is constituted to correspond to the MPEG-2 technical standard. Therefore, when digital signal encoded in compliance with a different technical standard such as MPEG-3 technical standards will be delivered in the future, it is necessary to constitute the signal decoder 12 to correspond to the different technical standard.

Subsequently a motion of the digital TV broadcast signal receiving system while it receives the TV broadcast signal is described.

The tuner 6 of the outdoor appliance 1 receives a TV broadcast signal (RF signal) transmitted from any TV tower through the multi-directional antenna 30 and the antenna controller 5, and it outputs the received TV broadcast signal to the signal demodulator 7. The signal demodulator 7 demodulates the received TV broadcast signal from the tuner 6 and outputs as the MPEG-TS signal to the first wireless interface 8. The first wireless interface 8 transmits the MPEG-TS signal to the second wireless interface 11 of the indoor appliance 2 in compliance with technical standard such as IEEE802.11x appropriately. The second wireless interface 11 of the indoor appliance 2 receives the signal transmitted from the first wireless interface 8, acquires the MPEG-TS signal by performing a process in compliance with the technical standard such as IEEE802.11x, and outputs the MPEG-TS signal to the signal decoder 12. The signal decoder 12 decodes the MPEG-TS signal and outputs the audio signal and visual signal acquired by decoding the MPEG-TS signal to the monitor apparatus. Thereby, the TV broadcast signal can be received by the indoor appliance 2 with laying no cable between the outdoor appliance 1 placed in the outdoor location and the indoor appliance 2 placed in the indoor location.

Subsequently, the motion of the digital TV broadcast signal receiving system while a reception channel is changed is described.

When a command to change the reception channel is inputted by a user, the second main controller 13 of the indoor appliance 2 outputs a control signal for changing the reception channel to the second wireless interface 11. The second wireless interface 11 transmits the control signal to the first wireless interface 8 of the outdoor appliance 1 in compliance with the technical standard such as IEEE802.11x. The first wireless interface 8 receives the control signal transmitted from the second wireless interface 11 in compliance with the technical standard such as IEEE802.11x, and outputs the received control signal to the first main controller 9. The first main controller 9 changes the reception frequency of the tuner 6 corresponding to the reception channel of the control signal.

Hereupon, the direction of the TV tower from which the TV broadcast signal of the changed reception channel is transmitted may be varied from the direction of the TV tower from which the TV broadcast signal of previously set reception channel is transmitted. In such a case, the S/N of the signal outputted from the tuner 6 may become worse, so that the first main controller 9 judges whether the signal receiving direction of the changed reception channel is the same as that of the previously set reception channel or not. When the signal receiving direction of the changed reception channel is not the same as that of the previously set reception channel, the first main controller 9 further outputs an antenna control through the signal demodulator 7 to the antenna controller 5 corresponding to the changed reception channel. The antenna controller 5 further outputs an antenna control signal and supplies drive voltage to the multi-directional antenna 30 for changing the effective signal receiving direction of the multi-directional antenna 30. Thereby, the effective signal receiving direction of the multi-directional antenna 30 can be optimized corresponding to the reception channel.

As mentioned above, according to the digital TV broadcast signal receiving system in accordance with this embodiment, the data communication is bi-directionally performed between the outdoor appliance 1 comprising the antenna controller 5, the tuner 6 and the signal demodulator 7 and the indoor appliance 2 comprising the signal decoder 12, and so on by the first wireless interface 8 and the second wireless interface 11. Thus, the cable laid into the indoor from the outdoor can be omitted, so that an initial cost for introducing the digital TV broadcast signal receiving system using the multi-directional antenna can be reduced.

Furthermore, the signal received by the tuner 6 and demodulated by the signal demodulator 7 which are provided in the outdoor appliance 1 is transmitted by a format in compliance with a predetermined wireless LAN technical standard or IEEE 1394 technical standard, so that an appliance comprising a second wireless interface and a signal decoder such as a personal computer comprising a wireless interface in compliance with IEEE802.11x and software of MPEG decoding) can be used as the indoor appliance 2, even if it comprises no tuner 6.

Still furthermore, when the reception channel is changed, a control signal corresponding to the changed reception channel is transmitted from the indoor appliance 2 to the outdoor appliance 1, so that the reception frequency of the tuner 6 of the outdoor appliance 1 is changed, and an antenna control signal is outputted from the signal demodulator 7 to the antenna controller 5, if necessary. The antenna controller 5 further outputs the antenna control signal and supplied driving voltage to the multi-directional antenna 30 for changing the effective signal receiving direction of the multi-directional antenna 30. Thus, the effective signal receiving direction of the multi-directional antenna 30 can be optimized, and the user can view the TV program with the always best reception condition.

In addition, the present invention is not limited to the above-mentioned configuration of the embodiment, and can be modified in various manners. For example, an apparatus having circuits corresponding to the second wireless interface 11 and the signal decoder 12 such as a television receiver having a wireless LAN function may be used as the indoor appliance 2 other than the set top box or the personal computer. In this way, a selectable area of the appliance for the indoor appliance 2 can be spread, so that a plurality of indoor appliances 2 can be placed in each room and can receive the same TV program of the same reception channel by a plurality of indoor appliances 2, simultaneously. In addition, when a plurality of lineages of the tuners 6 and the signal demodulators 7 is provided in the outdoor appliance 1, it is possible to receive different broadcast signals of different reception channels by a plurality of the indoor appliances 2, simultaneously.

Still furthermore, a bit rate converter may be built-in the outdoor appliance 1. In such a case, it is possible to reduced corresponding to the data communication capability between the first wireless interface 8 and the second wireless interface 11, so that occurrence of time delay of audio signal or dropping frames of visual signal can be prevented.

This application is based on Japanese patent application 2004-349811 filed Dec. 2, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A digital TV broadcast signal receiving system comprised of an outdoor appliance placed in an outdoor location and an indoor appliance placed in an indoor location, wherein
the outdoor appliance has:
an antenna controller to which a multi-directional antenna is connected and which controls an effective signal receiving direction of the multi-directional antenna;
a tuner for receiving a TV broadcast signal through the multi-directional antenna and the antenna controller;
a signal demodulator for demodulating the TV broadcast signal received by the tuner;
a first main controller for controlling each department of the indoor appliance; and
a first wireless interface for transmitting the demodulated signal by a format in compliance with a predetermined technical standard; and
the indoor appliance has:
a second wireless interface for receiving the demodulated signal transmitted from the first wireless interface in compliance with the predetermined technical standard;
a signal decoder for decoding the demodulated signal received by the second wireless interface, separating the demodulated signal into an audio signal and a visual signal and outputting them to a monitor apparatus; and
a second main controller for controlling each department of the indoor appliance.

2. The digital TV broadcast signal receiving system in accordance with claim 1, wherein
the second main controller outputs a control signal when reception channel is changed by a user;
the second wireless interface transmits the control signal to the first wireless interface in compliance with the predetermined technical standard;
the first wireless interface receives the control signal in compliance with the predetermined technical standard and outputs the received control signal to the first main controller;
the first main controller changes reception frequency of the tuner corresponding to the control signal, judges whether a signal receiving direction of a changed reception channel is same as that of a previously set reception channel or not, and when the signal receiving direction of the changed reception channel is not the same as that of the previously set reception channel, the first main controller further outputs an antenna control signal to the antenna controller corresponding to the changed reception channel; and
the antenna controller outputs the antenna control signal and supplies drive voltage to the multi-directional antenna for changing the effective signal receiving direction, thereby, the effective signal receiving direction of the multi-directional antenna can be optimized corresponding to the reception channel.

3. A digital TV broadcast signal receiving system comprising:
an antenna control means to which a multi-directional antenna having a plurality of signal receiving directions and which controls an effective signal receiving direction of the multi-directional antenna;
a tuner for receiving a TV broadcast signal through the multi-directional antenna and the antenna control means;
a signal demodulation means for demodulating the TV broadcast signal received by the tuner; and
a signal decoding means for decoding the demodulated signal, separating the demodulated signal into an audio signal and a visual signal and outputting them to a monitor apparatus; wherein the antenna control means, the tuner and the signal demodulation means are provided in an outdoor appliance placed in an outdoor location, and the signal decoding means is provided in an indoor apparatus which is placed in an indoor location and can perform bidirectional data communication with the outdoor appliance;
a photovoltaic means for supplying electric power to each department of the outdoor appliance and to the multi-directional antenna, a first wireless interface which perform wireless communication with the indoor appliance in compliance with a predetermined wireless LAN technical standard or IEEE 1394 technical standard, and a first control means for controlling each department of the outdoor appliance are further provided in the outdoor appliance;
a second wireless interface which perform wireless communication with the outdoor appliance and a second control means for controlling each department of the indoor appliance are further provided in the indoor appliance;
the first wireless interface transmits the demodulated signal by the signal demodulation means to the second wireless interface, and the second wireless interface transfers the received demodulated signal to the signal decoding means;
when a reception channel of the tuner is changed, the second control means transmits a control signal for changing the reception channel of the tuner to the first control signal through the second wireless interface and the first wireless interface;
the first control means changes reception frequency of the tuner corresponding to the control signal, judges whether a signal receiving direction of a changed reception channel is same as that of a previously set reception channel or not, and when the signal receiving direction of the changed reception channel is not the same as that of the previously set reception channel, the first control means further outputs an antenna control signal to the antenna control means corresponding to the changed reception channel;
the antenna control means outputs an antenna control signal and supplies drive voltage to the multi-directional antenna for changing the effective signal receiving direction, thereby, the digital TV broadcast signal can be received by the indoor appliance and the reception channel can be changed from the indoor appliance with laying no cable from the outdoor to the indoor, and the effective signal receiving direction of the multi-directional antenna can be optimized corresponding to the reception channel.

4. An outdoor appliance used in a digital TV broadcast signal receiving system comprising:
an antenna controller to which a multi-directional antenna is connected and which controls an effective signal receiving direction of the multi-directional antenna;
a tuner for receiving a TV broadcast signal through the multi-directional antenna and the antenna controller;
a signal demodulator for demodulating the TV broadcast signal received by the tuner;
a main controller for controlling each department of the indoor appliance;
a wireless interface for transmitting the demodulated signal by a format in compliance with a predetermined technical standard with another wireless interface provided in an indoor apparatus placed in an indoor location; and
a solar cell for supplying electric power to each department of the outdoor appliance and to the multi-directional antenna.

5. The outdoor appliance used in a digital TV broadcast signal receiving system in accordance with claim 4, wherein the solar cell is provided on a top face or a front face of a housing of the outdoor appliance;
a heat sink for radiating heat generated by electronic elements mounted in an inside of the outdoor appliance is provided on a bottom face or a rear face of the housing; and
the housing has properties of adiathermanous and waterproof, so that each element in the inside of housing of the outdoor appliance is protected from heat and water by the heat sink and the housing.
